(19) United States
(12) Patent Application Publication
(10) Pub. No.: US 2025/0016576 A1
(43) Pub. Date: Jan. 9, 2025

(54) FREQUENCY SITUATION OBSERVATION SYSTEM, FREQUENCY SITUATION OBSERVATION METHOD, CONTROL DEVICE, AND CONTROL PROGRAM

(71) Applicant: Nippon Telegraph and Telephone Corporation, Tokyo (JP)

(72) Inventors: Shoko SHINOHARA, Musashino-shi, Tokyo (JP); Yusuke Asai, Musashino-shi, Tokyo (JP); Yasushi TAKATORI, Musashino-shi, Tokyo (JP); Junichi Iwatani, Musashino-shi, Tokyo (JP); Yoshitaka SHIMIZU, Musashino-shi, Tokyo (JP); Tomoyuki Yamada, Musashino-shi, Tokyo (JP)

(21) Appl. No.: 18/708,488

(22) PCT Filed: Nov. 19, 2021
(86) PCT No.: PCT/JP2021/042647

§ 371 Date: May 8, 2024

(51) Int. Cl. H04W 16/18; H04L 5/00; H04W 28/20

(52) U.S. Cl. CPC H04W 16/18; H04L 5/0048; H04W 28/20

(57) ABSTRACT

A frequency state observation system according to an embodiment includes a spectrum observation device that observes a spectrum of a frequency range that can be used by a plurality of wireless communication systems, a control device that controls the spectrum observation device to perform a plurality of single sweeps over the frequency range, and a wireless communication device that transmits, by a radio signal, information indicating a frequency of occurrence of a signal having a predetermined threshold or more included in a spectrum observed by the spectrum observation device performing a plurality of single sweeps, with respect to a predetermined time.

### TECHNICAL FIELD

The present invention relates to a frequency state observation system, a frequency state observation method, a control device, and a control program.

### BACKGROUND ART

Conventionally, various wireless communication systems are often used to share the same frequency band within a predetermined area.

For example, in a license-free zone in Japan, a rule for carrying out carrier sensing (or listen before talk) for each casing of each wireless communication device and starting transmission after confirming a peripheral transmission signal for a predetermined amount of time or longer is used as a coexistence technique between different wireless systems.

However, even if the coexistence technique such as carrier sensing is used, if a plurality of different wireless communication systems using the same frequency band coexist, the utilization efficiency of the frequency becomes lower due to a frame collision or the like than the situation where wireless communication systems do not coexist.

Therefore, in order to maximize the frequency utilization efficiency, it is important for each of a plurality of different wireless communication systems to ascertain the congestion of radio waves in the shared frequency band and select a channel to be utilized.

In addition, in order to ascertain congestion of a frequency band to be used, for example, a wireless LAN can ascertain the number of master units arranged in each channel, on the basis of beacon information and signal intensity transmitted by the master unit (for example, see NPL 1).

Also, there has been known a technique for performing a continuous sweep for a fixed period of time using a spectrum analyzer and confirming whether a predetermined frequency band is even slightly used or not, based on the maximum value (max hold) detected at the time of continuous sweep (see, for example, NPL 2).

### CITATION LIST

### Non Patent Literature

[NPL 1] Naoya Matsumura, “Wi-Fi Technology Lecture No. 2 Beacon is a Notification Signal,” Wireless LAN Business Promotion Liaison Committee, Wi-Biz Communications Vol. 24 News & Topics, Jan. 15, 2018 newsletter, [online], Internet <URL: https://www.wlan-business.org/archives/12421>
[NPL 2] “Basics and Overview of Spectrum Analyzer (Part 2),” TechEyesOnline, Technical Information and Reports 2121 Apr. 6, [online], Internet <URL:https://www.techeyesonline.com/tech-column/detail/Reference-SpectrumAnalyzer-02/>

### SUMMARY OF INVENTION

### Technical Problem

However, for example, when a wireless LAN terminal uses beacon information, since a wireless LAN frame is detected, other wireless communication systems having different standards cannot be detected. Further, since the wireless LAN terminal observes the beacon frame and detects only that the BSS (Basic Service Set) exists in the periphery, hence the frequency of use of radio waves in actual communication is unknown.

In addition, in the conventional technique for confirming whether or not a predetermined frequency band is used even a little by using a spectrum analyzer, congestion of the frequency band cannot be ascertained at the use frequency or time ratio.

The present invention has been made in view of the above-mentioned problem, and an object of the present invention is to provide a frequency state observation system, a frequency state observation method, a control device, and a control program, which can observe a frequency usage state at a predetermined time in a frequency range that may be used by a plurality of wireless communication systems.

### Solution to Problem

A frequency state observation system according to one embodiment of the present invention includes a spectrum observation device that observes a spectrum of a frequency range that can be used by a plurality of wireless communication systems, a control device that controls the spectrum observation device to perform a plurality of single sweeps over the frequency range, and a wireless communication device that transmits, by a radio signal, information indicating a frequency of occurrence of a signal having a predetermined threshold or more included in a spectrum observed by the spectrum observation device performing a plurality of single sweeps, with respect to a predetermined time.

A frequency state observation method according to one embodiment of the present invention includes a control step of controlling a spectrum observation device to perform a plurality of single sweeps over a frequency range that can be used by a plurality of wireless communication systems, the spectrum observation device observing a spectrum of the frequency range, and a wireless communication step of transmitting, by a radio signal, information indicating a frequency of occurrence of a signal having a predetermined threshold or more included in a spectrum observed by the spectrum observation device performing a plurality of single sweeps, with respect to a predetermined time.

A control device according to one embodiment of the present invention includes a sweep control unit that controls a spectrum observation device to perform a plurality of single sweeps over a frequency range that can be used by a plurality of wireless communication systems, the spectrum observation device observing a spectrum in the frequency range, and a tabulation unit that tabulates a frequency of occurrence of a signal having a predetermined threshold or more included in a spectrum observed by the spectrum observation device performing a plurality of single sweeps, with respect to a predetermined time.

### Advantageous Effects of Invention

According to the present invention, it is possible to observe a frequency usage at a predetermined time in a frequency range that can be used by a plurality of wireless communication systems.

### BRIEF DESCRIPTION OF DRAWINGS

FIG. 1 is a diagram illustrating a configuration of a frequency state observation system according to an embodiment and its surroundings.

FIG. 2 is a functional block diagram illustrating functions of a control device according to one embodiment.

FIG. 3(a) is a diagram showing a required value for an observation to be executed by a spectrum observation device. FIG. 3(b) is a diagram showing a set value calculated by a set value calculation unit.

FIG. 4 is a diagram illustrating a result stored in a storage unit.

FIG. 5 is a diagram illustrating results tabulated by a tabulation unit.

FIG. 6 is a flow chart illustrating an outline of an operation of a frequency state observation system.

FIG. 7 is a flow chart illustrating an outline of an operation of the frequency state observation system.

FIG. 8 is a flowchart showing another example of the outline of the operation of the frequency state observation system.

FIG. 9 is a diagram showing an example of a hardware configuration of the control device according to an embodiment.

### DESCRIPTION OF EMBODIMENTS

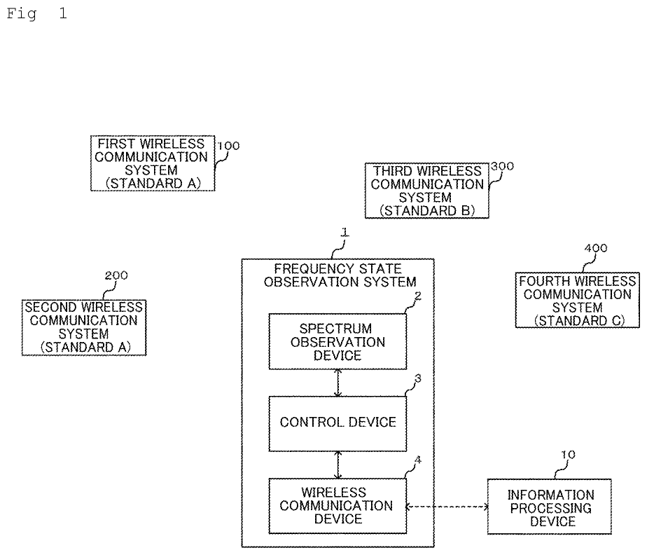

A frequency state observation system according to an embodiment will be described hereinafter using the drawings. FIG. 1 is a diagram illustrating a configuration of a frequency state observation system 1 according to an embodiment and its surroundings.

As shown in FIG. 1, the frequency state observation system 1 is disposed in the vicinity of, for example, a first wireless communication system 100, a second wireless communication system 200, a third wireless communication system 300, and a fourth wireless communication system 400, and observes a peripheral frequency usage.

For example, the first wireless communication system 100, the second wireless communication system 200, the third wireless communication system 300, and the fourth wireless communication system 400 are wireless communication systems in which base stations, terminals, and the like, not shown in the drawings, respectively, perform wireless communication in accordance with any one of a plurality of wireless communication standards A to C (Standards A to C).

The frequency state observation system 1 can perform wireless communication with, for example, an information processing device 10. The frequency state observation system 1 also transmits a result of observation of a peripheral frequency usage to the information processing device 10.

Specifically, the frequency state observation system 1 includes a spectrum observation device 2, a control device 3, and a wireless communication device 4, and observes a peripheral frequency usage.

The spectrum observation device 2 observes a spectrum in a frequency range that can be used by a plurality of wireless communication systems, and outputs the spectrum to the control device 3. For example, the spectrum observation device 2 can observe a spectrum on both axes of frequency and time.

The control device 3 controls each of the units constituting the frequency state observation system 1. For example, the control device 3 controls the spectrum observation device 2 to perform a plurality of single sweeps for the above-mentioned frequency range. The control device 3 also performs processing to be described later on each spectrum output by the spectrum observation device 2, and outputs the processing result and the like to the wireless communication device 4.

The control device 3 is connected to the spectrum observation device 2 and the wireless communication device 4 by, for example, a serial interface such as GPIO (General Purpose Input/Output) or a control interface such as Ethernet®. The control device 3 may be included in the spectrum observation device 2.

The wireless communication device 4 transmits the processing result output by the control device 3 to, for example, the information processing device 10 or the like by wireless communication. For example, the wireless communication device 4 transmits information indicating the frequency of occurrence of a signal having a predetermined threshold or more included in a spectrum observed by the spectrum observation device 2 performing a plurality of single sweeps, with respect to a predetermined time, by means of a radio signal.

The information processing device 10 is a computer or the like for performing predetermined processing on information received from the frequency state observation system 1.

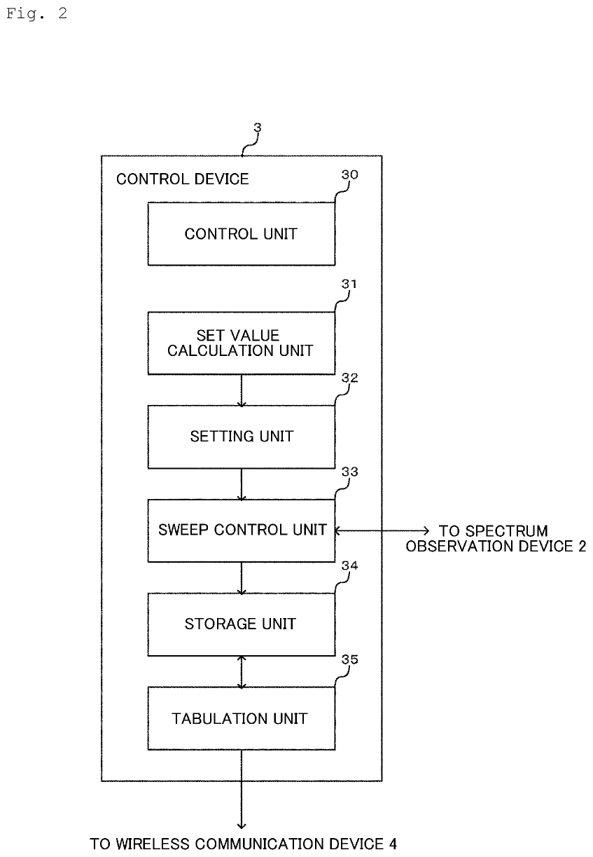

The foregoing control device 3 will be described next in further detail. FIG. 2 is a functional block diagram showing functions of the control device 3 according to an embodiment. As shown in FIG. 2, the control device 3 includes, for example, a control unit 30, a set value calculation unit 31, a setting unit 32, a sweep control unit 33, a storage unit 34, and a tabulation unit 35.

The control unit 30 controls the spectrum observation device 2 and the wireless communication device 4 by controlling each unit constituting the control device 3.

The set value calculation unit 31 calculates, for example, a set value such as a sweep time when the spectrum observation device 2 performs a single sweep, based on a frequency bandwidth or a signal time that can be used by each of the first wireless communication system 100, the second wireless communication system 200, the third wireless communication system 300 and the fourth wireless communication system 400, and outputs the calculated set value to the setting unit 32.

Specifically, the set value calculation unit 31 calculates time required for a single sweep, on the basis of a frequency bandwidth and signal time of a plurality of radio signals expected to be transmitted in a frequency band of each wireless communication system.

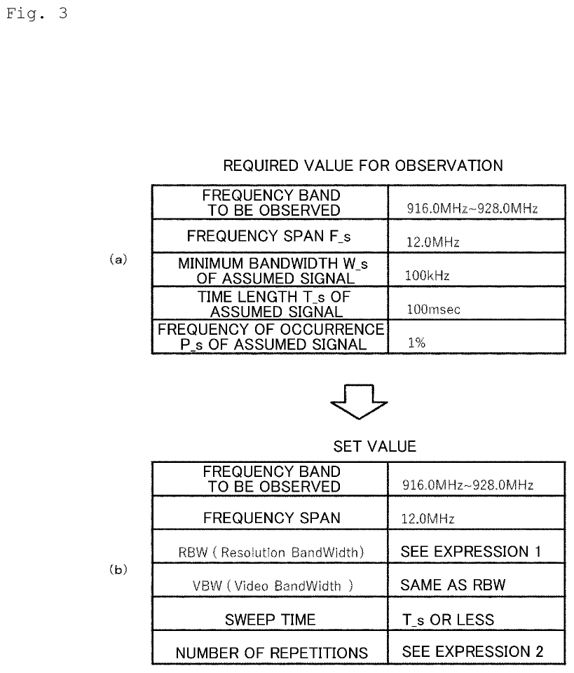

For example, the set value calculation unit 31 calculates the set value as shown in FIG. 3 and the like. FIG. 3 is a diagram showing a required value for an observation to be executed by the spectrum observation device 2 and a set value calculated by the set value calculation unit 31. FIG. 3(a) is a diagram showing a required value for an observation to be executed by the spectrum observation device 2. FIG. 3(b) is a diagram showing a set value calculated by the set value calculation unit 31.

For example, as shown in FIG. 3(a), suppose that the required values for the observation to be executed by the spectrum observation device 2 are such that the frequency band to be observed is 916.0 MHz to 928.0 MHZ, the frequency span F_s is 12.0 MHz, the minimum bandwidth W_s of an assumed signal is 100 kHz, the signal length T_s of the assumed signal is 100 msec, and the frequency of occurrence P_s of the assumed signal is 1%.

The frequency of occurrence P_s of the assumed signal may be the lowest frequency of occurrence of a signal for which that the operator wants to confirm the impact of radio wave interference or the like. That is, if the frequency of occurrence P_s of a signal may be equal to or less than the minimum frequency of occurrence, the operator does not confirm radio waves because there is substantially no impact on radio wave interference or the like.

At this time, as shown in FIG. 3(b), the set value calculation unit 31 calculates the set value so that the observed frequency band is 916.0 MHz to 928.0 MHZ, the frequency span is 12.0 MHZ, RBW (Resolution Bandwidth) is either W1 (formula (1) below) or W2 (formula (2) below) whichever smaller, VBW (Video Bandwidth) is the same as RBW, sweep time is Ts or less, and the number of times a single sweep is repeated is the following formula (3).

$$\begin{matrix}[ Math . 1 ] & \\ W 1 = W\_s / 2 & ( 1 )\end{matrix}$$

$$\begin{matrix}[ Math . 2 ] & \\ W 2 = {( K \cdot F\_s / T\_s )}^{\frac{1}{2}} & ( 2 )\end{matrix}$$

$$\begin{matrix}[ Math . 3 ] & \\ 100 / P\_s & ( 3 )\end{matrix}$$

Examples of an active tag wireless system often used in a 920 MHz band include LORA (one of the standards of LPWA: Low Power Wide Area) and WiSUN (Wireless Smart Utility Network).

LoRa is set to 125 kHz width, and WiSUN is set to 400 kHz width. In this case, the set value calculation unit 31 performs calculation so that the RBW can be set to 63 kHz or less which is ½ of 125 kHz, so as to analyze the signal of the LoRa.

The set value calculation unit 31 may also calculate the optimum sweep time from the above-mentioned value. Further, when the frame time length of each wireless communication system is 100 msec, the set value calculation unit 31 needs to have a sweep time of 100 msec or less, and therefore, for example, the sweep time (grain size) may be set to 10 msec to set the RBW.

The setting unit 32 (FIG. 2) outputs the set value calculated by the set value calculation unit 31 to the sweep control unit 33. That is, the setting unit 32 sets, to the sweep control unit 33, a sweep time or the like when the spectrum observation device 2 performs a single sweep, on the basis of a frequency bandwidth or a signal time that can be used by each wireless communication system.

The sweep control unit 33 controls the spectrum observation device 2 on the basis of the set value set by the setting unit 32. That is, the sweep control unit 33 controls the spectrum observation device 2 to perform a plurality of single sweeps over a frequency range that can be used by each wireless communication system, the spectrum observation device 2 observing the spectrum of the frequency range. Then, the sweep control unit 33 acquires a result of the spectrum observation device 2 performing a plurality of single sweeps, and outputs the result to the storage unit 34.

The storage unit 34 stores the result output by the sweep control unit 33 (the result obtained by the spectrum observation device 2 performing a plurality of single sweeps: scan result).

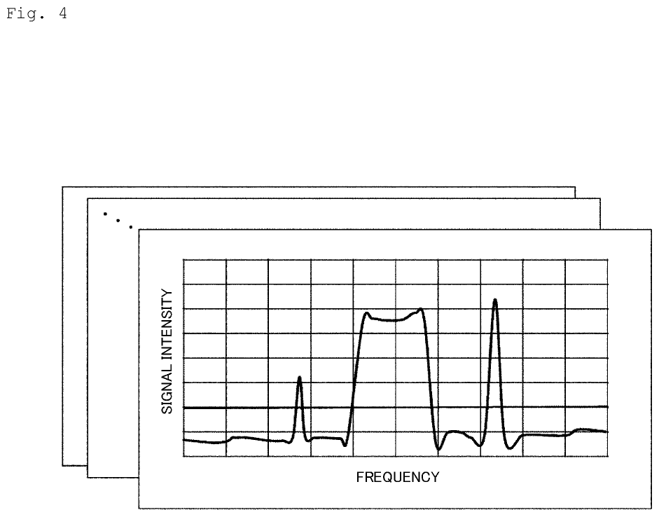

FIG. 4 is a diagram illustrating the result stored in the storage unit 34 (the result obtained by the spectrum observation device 2 performing a plurality of single sweeps). As shown in FIG. 4, the storage unit 34 stores each of the single sweep results for the number of times set by the setting unit 32.

The tabulation unit 35 reads out the results stored in the storage unit 34, tabulates the frequency of occurrence or the like of a signal having a predetermined threshold or more included in the spectrum observed by the spectrum observation device 2 performing a plurality of single sweeps, with respect to a predetermined time, and outputs it to the wireless communication device 4.

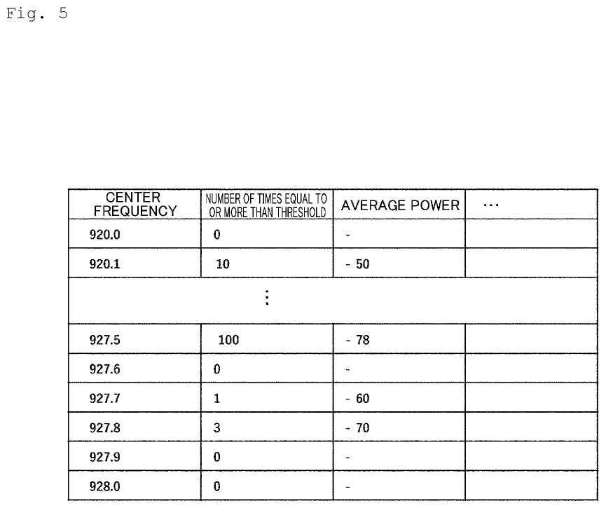

FIG. 5 is a diagram illustrating results tabulated by the tabulation unit 35. As shown in FIG. 5, the tabulation unit 35 tabulates the number of times when, for example, the power becomes equal to or greater than a carrier sense threshold, or the number of times when the signal intensity (interference signal power) becomes equal to or greater than the predetermined threshold, for each spectrum observed by the spectrum observation device 2 performing a plurality of single sweeps.

That is, the tabulation unit 35 compresses the data (management data) to be processed by the information processing device 10 or the like by aggregating not the scan result itself obtained by the spectrum observation device 2 but the number of times of signal occurrence of a certain level or more as the measurement result.

In this manner, according to the control of the control unit 30, the tabulation unit 35 outputs information indicating the frequency of occurrence of a signal having a predetermined threshold or more included in the spectrum observed by the spectrum observation device 2, with respect to a predetermined time, to the wireless communication device 4 while reducing the amount of data.

Then, the wireless communication device 4 transmits information or the like indicating the frequency of occurrence output by the control device 3 (tabulation unit 35), to the information processing device 10 or the like.

A plurality of the frequency state observation systems 1 may be arranged in the vicinity of each wireless communication system. In this case, the control device 3 of each of the frequency state observation systems 1 may be configured to receive the information transmitted by the other frequency state observation systems 1, and transmit the information only when the frequency of occurrence tabulated by the own device is higher than the frequency of occurrence indicated by the information received from the other frequency state observation systems 1.

For example, each of the plurality of frequency state observation systems 1 may be configured to transmit a tabulation result of the own device to the other frequency state observation systems 1 as a broadcast content in a notification frame (for example, NDPA frame) of the wireless LAN, and transmit information only when the frequency of occurrence tabulated by the own device is high.

That is, the control device 3 may be configured to output information indicating the frequency of occurrence of a signal having a predetermined threshold or more included in a spectrum observed by the spectrum observation device 2, with respect to a predetermined time, to the wireless communication device 4 while reducing the number of outputs.

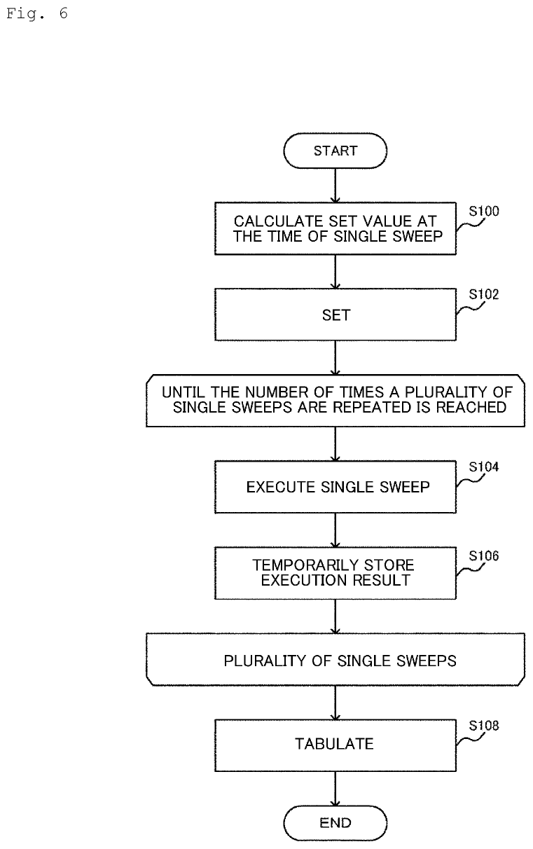

Next, an example of an operation of the frequency state observation system 1 is described. FIG. 6 is a flow chart illustrating an outline of the operation of the frequency state observation system 1 (up to the tabulation of single sweep results). As shown in FIG. 6, in the frequency state observation system 1, for example, the control device 3 calculates a set value when the spectrum observation device 2 performs a single sweep (S100).

Then, the control device 3 sets the calculated set value to the spectrum observation device 2 (S102).

The spectrum observation device 2 repeats the processing of the execution of a single sweep (S104) and the temporary storage of the execution result (S106) until the number of repetitions set by the control device 3 is reached. For example, the spectrum observation device 2 performs a single sweep of 1 msec to detect a signal of 10 msec. That is, the spectrum observation device 2 may save power by providing a time period during which the single sweep is not performed.

Thereafter, the control device 3 performs processing for tabulating results obtained by the spectrum observation device 2 performing a plurality of single sweeps (S108).

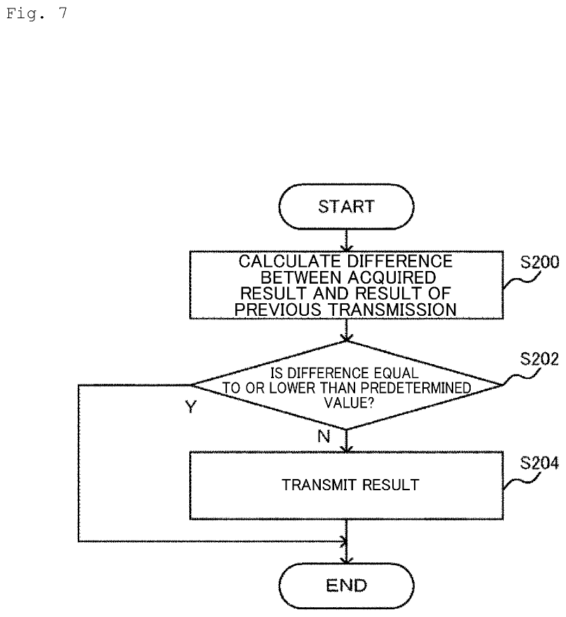

FIG. 7 is a flow chart illustrating an outline of the operation of the frequency state observation system 1 (up to the transmission of single sweep results). As shown in FIG. 7, the frequency state observation system 1 calculates a difference between a result (power or frequency) acquired from the spectrum observation device 2 by the control device 3 and a result transmitted last time (S200).)

The frequency state observation system 1 determines whether or not the calculated difference is equal to or less than a predetermined value (S202), advances to the processing of S204 when the difference is not equal to or less than the predetermined value (S202: No), and ends the processing when the difference is equal to or less than the predetermined value (S202: Yes).

In the processing of S204, the wireless communication device 4 of the frequency state observation system 1 transmits the result (a result after tabulating) to the information processing device 10 or the like.

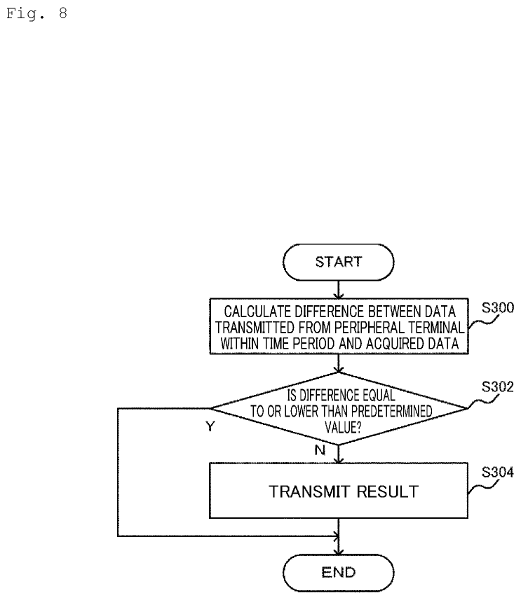

FIG. 8 is a flowchart showing another example of the outline of the operation of the frequency state observation system 1 (up to the transmission of the tabulation result). As shown in FIG. 8, the control device 3 of the frequency state observation system 1 calculates a difference between data transmitted from a peripheral terminal (another frequency state observation system 1) within a predetermined time period and data acquired from the spectrum observation device 2 by the own device (S300).

The frequency state observation system 1 determines whether or not the calculated difference is equal to or less than a predetermined value (S302), advances to the processing of S304 when the difference is not equal to or less than the predetermined value (S302: No), and ends the processing when the difference is equal to or less than the predetermined value (S302: Yes).

In the processing of S304, the wireless communication device 4 of the frequency state observation system 1 transmits the result (a result after tabulating) to the information processing device 10 or the like.

In this manner, the frequency state observation system 1 according to one embodiment can tabulate the frequency of occurrence of a signal having a predetermined threshold or more included in a spectrum observed by a plurality of single sweeps, with respect to a predetermined time, and observe the frequency usage in the predetermined time in a frequency range that can be used by a plurality of wireless communication systems.

Also, in the frequency state observation system 1, since the setting unit 32 sets the set value calculated by the set value calculation unit 31, the accuracy and efficiency of the tabulation result can be improved. Further, the frequency state observation system 1 can improve the efficiency of the observation of the frequency state by reducing at least either the data amount or the number of outputs of information indicating the frequency of occurrence of a signal having a predetermined threshold or more included in the spectrum observed by the spectrum observation device 2, with respect to a predetermined time.

The frequency state observation system 1 can also aggregate information on a plurality of single sweeps in order to grasp not only the number of terminals and signal intensity in a frequency band of each wireless communication system but also a time ratio in which a frequency is used.

Note that each function of the control device 3 and the information processing device 10 may be configured in whole or in part by hardware such as a PLD (Programmable Logic Device) or FPGA (Field Programmable Gate Array), or may be configured as a program executed by a processor such as a CPU.

For example, the control device 3 and the information processing device 10 can each be realized by using a computer and a program, and the program can be recorded in a storage medium or can be provided through a network.

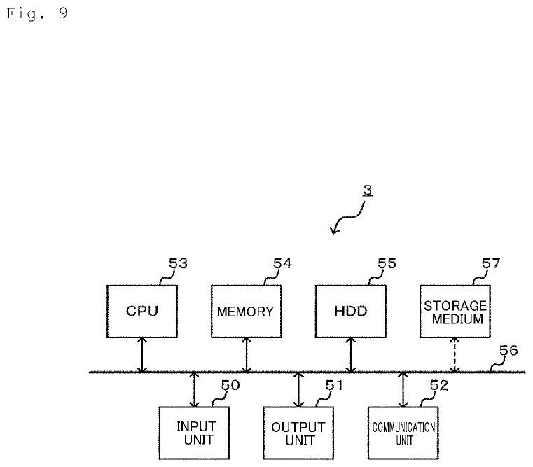

FIG. 9 is a diagram showing an example of a hardware configuration of the control device 3 according to an embodiment. As shown in FIG. 9, for example, the control device 3 has an input unit 50, an output unit 51, a communication unit 52, a CPU 53, a memory 54, and an HDD 55 connected via a bus 56 with each other, and functions as a computer. The control device 3 is configured to be able to input/output data to/from a computer-readable storage medium 57.

The input unit 50 is, for example, a keyboard, a mouse, and the like. The output unit 51 is, for example, a display device such as a display. The communication unit 52 is, for example, a network interface.

The CPU 53 controls each unit constituting the control device 3 and performs predetermined processing and the like. The memory 54 and the HDD 55 correspond to the above-described storage unit 34 (FIG. 2) that stores data or the like.

The storage medium 57 is capable of storing a program and the like for executing the functions of the control device 3. The architecture constituting the control device 3 is not limited to the example shown in FIG. 9.

### REFERENCE SIGNS LIST

1 Frequency state observation system
2 Spectrum observation device
3 Control device
4 Wireless communication device
10 Information processing device
30 Control unit
31 Set value calculation unit
32 Setting unit
33 Sweep control unit
34 Storage unit
35 Tabulation unit
50 Input unit
51 Output unit
52 Communication unit
53 CPU
54 Memory
55 HDD
56 Bus
57 Storage medium
100 First wireless communication system
200 Second wireless communication system
300 Third wireless communication system
400 Fourth wireless communication system

1. A frequency state observation system, comprising:
a spectrum observation device, including one or more processors, configured to observe a spectrum of a frequency range that can be used by a plurality of wireless communication systems;
a control device, including one or more processors, configured to control the spectrum observation device to perform a plurality of single sweeps over the frequency range; and
a wireless communication device, including one or more processors, configured to transmit, by a radio signal, information indicating a frequency of occurrence of a signal having a predetermined threshold or more included in a spectrum observed by the spectrum observation device performing a plurality of single sweeps, with respect to a predetermined time.

2. The frequency state observation system according to claim 1, wherein the control device is configured to set a sweep time when the spectrum observation device performs a single sweep, on the basis of a frequency bandwidth or a signal time that can be used by each of the wireless communication systems.

3. The frequency state observation system according to claim 1,
wherein the control device is configured to output, to the wireless communication device, information indicating a frequency of occurrence of a signal having a predetermined threshold or more included in a spectrum observed by the spectrum observation device, with respect to a predetermined time, while reducing at least either a data amount or the number of outputs, and the wireless communication device is configured to transmit the information indicating the frequency of occurrence output by the control device.

4. A frequency state observation method, comprising:
a control step of controlling a spectrum observation device to perform a plurality of single sweeps over a frequency range that can be used by a plurality of wireless communication systems, the spectrum observation device observing a spectrum of the frequency range; and
a wireless communication step of transmitting, by a radio signal, information indicating a frequency of occurrence of a signal having a predetermined threshold or more included in a spectrum observed by the spectrum observation device performing a plurality of single sweeps, with respect to a predetermined time.

5. The frequency state observation method according to claim 4, further comprising a setting step of setting a sweep time when the spectrum observation device performs a single sweep, on the basis of a frequency bandwidth or a signal time that can be used by each of the wireless communication systems.

6. A control device, comprising:
a sweep control unit, including one or more processors, configured to control a spectrum observation device to perform a plurality of single sweeps over a frequency range that can be used by a plurality of wireless communication systems, the spectrum observation device observing a spectrum in the frequency range; and
a tabulation unit, including one or more processors, configured to tabulate a frequency of occurrence of a signal having a predetermined threshold or more included in a spectrum observed by the spectrum observation device performing a plurality of single sweeps, with respect to a predetermined time.

7. The control device according to claim 6, further comprising a setting unit, including one or more processors, configured to set, to the sweep control unit, a sweep time when the spectrum observation device performs a single sweep, on the basis of a frequency bandwidth or a signal time that can be used by each of the wireless communication systems.

8. A non-transitory computer storage medium storing control program for causing a computer to function as each unit of the control device according to claim 6.
